(19) United States
(12) Patent Application Publication
(10) Pub. No.: US 2005/0123461 A1
(43) Pub. Date: Jun. 9, 2005

(54) Apparatus and process for the separation of particles from thermally after-treated process offgases

(75) Inventors: Andreas Frenzel, Dresden (DE); Wido Wiesenberg, Dresden (DE); Konrad Gehmlich, Meissen (DE); Horst Reichardt, Dresden (DE); Lothar Ritter, Langebruck (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: DAS-Dunnschicht Anlagen Systeme GmbH, Dresden (DE)

(21) Appl. No.: 10/993,466

(22) Filed: Nov. 19, 2004

(30) Foreign Application Priority Data
Nov. 24, 2003 (DE) 103 55 970.1

(51) Int. Cl. B01D 46/00

(52) U.S. Cl. 423/215.5; 95/149; 95/65

(57) ABSTRACT

The invention relates to an apparatus and a process for the separation of particles from thermally after-treated process offgases which are obtained, in particular, in the surface modification of various substrates in vacuum units. The invention provides, in accordance with its object, an inexpensive and effective way of carrying out the separation of very small solid particles present in thermally after-treated process offgases. The apparatus of the invention is configured so that the process offgases which have been thermally after-treated in combustion chambers are conveyed via a cooler through an agglomeration stage and solid particles present in the after-treated process offgas can be separated off in a scrubbing stage.

The invention relates to an apparatus and a process for the separation of particles from thermally after-treated process offgases, with these process offgases being obtained in the surface modification of various substrates. In such processes, the corresponding substrates are coated in vacuum units and both the substrates themselves and the corresponding vacuum chambers are cleaned by dry etching.

The process offgases formed in these processes and conveyed out of the vacuum units contain various chemical compounds which can not simply be discharged into the environment.

It is therefore customary for the process offgases obtained to be thermally after-treated by introducing them into a combustion chamber and converting them there into other chemical compounds.

Thus, for example, various silicon compounds are dissociated and the silicon is oxidized to SiO₂ in the thermal after-treatment.

This SiO₂ is then a constituent of the thermally after-treated process offgas in addition to solid particles which are present beforehand in the process offgas or have previously been formed in the process offgas. The solid particles present and formed in the process offgas have a particular particle size spectrum and, apart from relatively large solid particles, a certain proportion of very fine and extremely fine particles whose particle size is significantly below 1 μm are also present in the after-treated process offgas.

In the case of the vacuum units introduced in the recent past, relatively large-area substrates have to be and are always technologically treated, so that the process offgas volumes which are obtained and have to be after-treated are considerably larger.

Accordingly, the total amount of solid particles present in the after-treated process offgas and therefore also the absolute quantity of extremely fine solid particles in the after-treated process offgas increase.

These very fine, small solid particles can be separated off only very unsatisfactorily by means of the technologies used hitherto for the separation of solid particles present in after-treated process offgases, so that the amount of very small solid particles which have been subjected to a conventional thermal after-treatment and are discharged into the environment increases correspondingly.

However, a separation of such small extremely fine solid particles which may additionally nave to be carried out is very costly when conventional techniques are employed, since, for example, correspondingly fine filters can be used for only relatively short periods of time without a cleaning step.

Experiments using Venturi scrubbers for a separation of such very small particles also did not lead to the desired result, since either the pressure drop was very large or a very high energy was required to form the necessary liquid driving jet at Venturi nozzles.

It is therefore an object of the invention to be able to undertake an inexpensive and effective separation of very small solid particles present in thermally after-treated process offgases and to be able to set the thermally after-treated process offgases which have been separated in such a way free in a toxicologically and environmentally acceptable manner.

This object is achieved according to the invention by means of an apparatus having the features of claim 1 and by means of a process as defined in claim 15. Advantageous embodiments and further variants of the invention can be achieved by means of the features set forth in the subordinate claims.

The invention builds on conventional solutions for the thermal after-treatment of process offgases. Thus, the respective process offgas is introduced into a combustion chamber in which at least one burner is present. An after-treatment of the respective process offgas is carried out by feeding in a suitable fuel gas (e.g. CH₄, hydrogen or propane gas) and an oxidant (oxygen or air). Chemical compounds are associated under these conditions. The dissociation products are converted into other chemical compounds, for example hydrogen fluoride and oxides, with, for example, particulate silicon dioxide being formed from silicon. To avoid the formation of deposits on the interior wall of such combustion chambers, it is customary to create a film of a scrubbing liquid over this.

Before the thermally after-treated process offgas is fed to a scrubbing stage in which solid particles can be separated off and, for example, previously formed hydrogen fluoride can be transformed chemically, the after-treated process offgases are, according to the invention, cooled and at least part of the small solid particles formed are enlarged in terms of their volume by agglomeration in an intermediate agglomeration stage, so that the corresponding enlarged solid particles can be separated from the after-treated process offgas in the subsequent scrubbing stage.

This agglomeration stage is formed by at least one vessel in which the process offgas containing solid particles is kept for a particular residence time to enable the agglomeration leading to an enlargement of the volume of particles to occur.

Such a vessel should then be configured so that it has an appropriately large internal volume and the flow velocity within such a vessel is preferably reduced. For this purpose, the internal volume and/or the free internal cross section should be at least approximately at least as large as the internal volume and/or the free internal cross section of the combustion chamber. In this way, the respective flow velocity of the process offgas is reduced within the agglomeration stage.

The abovementioned residence time in the agglomeration stage should be at least 10 s, but preferably about 30 s.

However, the agglomeration stage can also be made up of more than one such vessel. A plurality of vessels can be arranged in series so that the process offgas flows through them in succession for the agglomeration.

Instead or in addition, it is also possible to arrange vessels of an agglomeration stage in parallel, so that a plurality of substream can be passed through the corresponding vessels for an agglomeration. Within such an individual stream, it is in turn possible for a plurality of vessels to be arranged in series.

It is also advantageous to provide the interior surface of one or all vessels of an agglomeration stage with a film of scrubbing liquid, so that adhesion of particles to the interior wall can be avoided and any particles occurring in this region can be rinsed off and passed to a subsequent scrubbing stage.

The agglomeration of particles can be aided by appropriate measures, for which there are a number of possibilities which can be employed alone or in combination.

Thus, agglomeration nuclei can be present in or be additionally introduced into the agglomeration stage. Such agglomeration nuclei can be, for example, droplets which have been sprayed in. Preference is given to a fine spray, so that the number of liquid droplets per unit volume is very high.

In another alternative, the agglomeration nuclei can be solid particles which are introduced into the agglomeration stage and are entrained by the after-treated process offgas stream and thus promote the agglomeration of particles to increase their volume.

Cooled, thermally after-treated process offgases leaving the combustion chamber should have a temperature at the inlet to the agglomeration stage which is below the boiling point of a liquid or a scrubbing liquid used, for example, in the quench stage.

The process offgas temperature at the inlet to the agglomeration stage should, however, be greater than the temperature of liquid droplets which have been sprayed in within the agglomeration stage, so that the agglomeration can be aided by thermophoresis.

A further possible way of aiding the agglomeration is to emit ultrasound waves into the interior of the agglomeration stage.

The agglomeration stage to be used according to the invention is in turn followed by a scrubbing stage through which the process offgas is conveyed. In this scrubbing stage, a very high proportion of solid particles, which has been increased by the agglomeration to be carried out according to the invention, can be separated off.

However, further critical chemical compounds present in the process offgas can also be bound or converted into nonhazardous chemical compounds by means of a suitable choice of scrubbing liquid. This applies, for example, to hydrogen fluoride.

An appropriate after-treatment of the process offgas can be achieved in the scrubbing stage by means of, for example, a driving jet of scrubbing liquid, a spray scrubber and/or a packed scrubbing column. The scrubbing stage should preferably be provided firstly with a spray scrubber by means of which blockages can be avoided. A driving jet of liquid likewise enables this to be avoided and at the same time enables an increase in the transport capacity to be achieved.

In packed scrubbing columns in which packing elements are located, a relatively large surface area is available for the absorption of harmful substances (e.g. hydrogen fluoride) present in the process offgas.

Depending on the design, particles and agglomerates larger than 0.7-1.5 μm can be separated from the after-treated process offgas in such a scrubbing stage. A certain proportion of smaller particles can pass through the scrubbing stage and the apparatus can be supplemented by installation of at least one downstream electrostatic precipitator.

Such an electrostatic precipitator makes it possible to achieve virtually complete separation of particles present in the after-treated process offgas. The use of such electrostatic precipitators is possible because the total amount of such very small solid particles has been significantly reduced beforehand, so that electrostatic precipitators can be loaded with particles for a relatively long period of time before the ionizing current generated by the high voltage breaks down and such a precipitator loses its effectiveness.

This can also be applied to the solution used according to the invention and a parallel arrangement of at least two electrostatic precipitators which can be operated alternately should be present if possible. For example, process offgas leaving the scrubbing stage can be passed through an electrostatic precipitator for the further separation of fine solid particles, while at the same time cleaning is carried out in a second electrostatic precipitator. Cleaning is effected by means of a washing liquid which flows through the electrostatic precipitator to be cleaned and removes and carries away the solid particles adhering to the precipitator.

After cleaning is complete, the process offgas stream can be switched over and passed through the cleaned electrostatic precipitator while the other electrostatic precipitator is cleaned in an analogous fashion during this time.

Since one particular treatment of the process offgas is to be carried out in each of the individual processes stages, the invention can advantageously be developed further by using different scrubbing liquids which differ in their consistency for the individual process steps.

Thus, for example, one scrubbing liquid can be used in the quench stage and the same scrubbing liquid can also be used for the cleaning of electrostatic precipitators.

A second scrubbing liquid can be fed to the agglomeration stage and the scrubbing stage.

The two scrubbing liquids can differ, for example, in their pH and/or in terms of substances present in solution.

The invention is illustrated by way of example below.

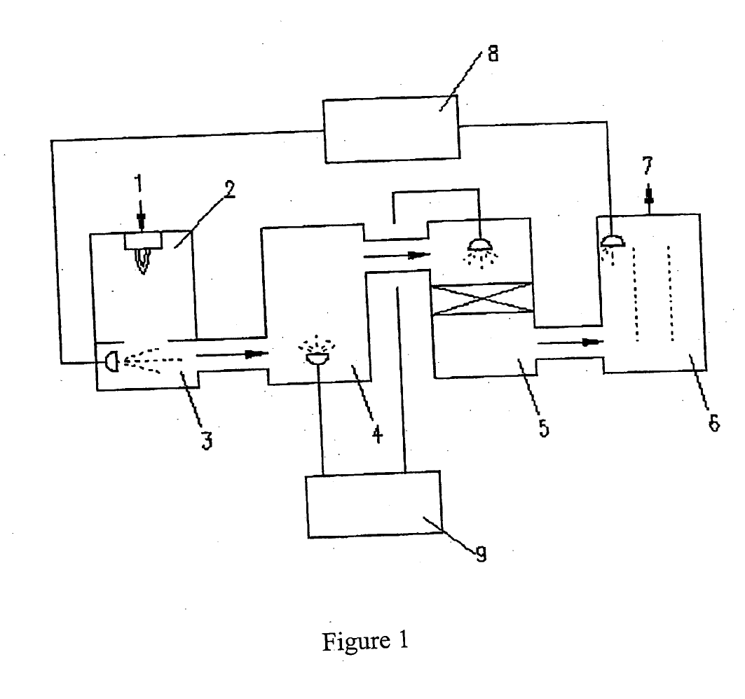

FIG. 1 schematically shows a block diagram of an example of an apparatus according to the invention.

The block diagram shown in FIG. 1 illustrates the invention by way of example.

Process offgas from a vacuum coating plant (not shown) travels via the process offgas inlet 1, as indicated by an arrow, into a combustion chamber 2. In the combustion chamber 2, a thermal after-treatment known per se of the process offgas is then carried out, as described in the introductory part of the description.

A quench stage 3 to which a first scrubbing liquid is f ed from the lank 8 is located at the bottom of the combustion chamber 2.

The thermally after-treated process offgas is cooled by means of the quench stage 3, with a temperature in the range from 30 to 60° C. being able to be achieved. The thermally after-treated and cooled process offgas goes via a connecting line to an agglomeration stage 4 which is formed by a plastic vessel having a relatively large volume.

In a form which is not shown, a preferably closed liquid film can be created on the interior wall of the combustion chamber 2 and on the interior wall of the agglomeration stage 4 in order to avoid adhesion of solid particles there.

To aid the agglomeration of extremely fine solid particles, a second scrubbing liquid from a tank 9 is sprayed into the interior of the agglomeration stage 4. The liquid should be sprayed in so that very fine liquid droplets which can form agglomeration nuclei are present within the agglomeration stage.

The agglomeration stage 4 is dimensioned so that, taking into account the volume flow of process offgas and the corresponding pressures, a residence time of at least 30 s can be adhered to for the agglomeration of fine small solid particles to be carried out according to the invention.

The process offgas, which has a relatively large proportion of solid particles having a relatively large volume achieved as a result of the agglomeration, is fed via a connecting line to a scrubbing stage 5 of which a packed column containing packing elements is an integral constituent and in which a separation of solid particles and also an absorption of hydrogen fluoride can be achieved by means of the second scrubbing liquid which is once again introduced from the tank 9 into the scrubbing stage 5.

In the examples shown here, the scrubbing stage 5 is followed, via a connecting line, by an electrostatic precipitator 6 through which the process offgas which is now very largely free of harmful substances and relatively large solid particles is conveyed.

This electrostatic precipitator 6 additionally enables the fine solid particles, whose number has been significantly reduced, to be separated from the process offgas and the process offgas to be released into the environment via an extraction facility 7. To allow cleaning of the electrostatic precipitator 6, it is connected to the tank 8 from which the first scrubbing liquid can be introduced into the electrostatic precipitator 6 for the purpose of cleaning and removal of the adhering fine solid particles.

However, in a form which is not shown but has likewise been described in the general part of the description, it is possible for a parallel arrangement of at least two electrostatic precipitators 6 which can be operated alternately for the separation of fine solid particles and for cleaning to be present.

In the block diagram of FIG. 1, outlets for liquid from the agglomeration stage 4, the scrubbing stage 5, the electrostatic precipitator 6, the combustion chamber 2 and the replacement and discharge of the scrubbing liquids into a wastewater treatment plant have not been depicted.

1. Apparatus for the separation of particles from thermally after-treated process offgases, in which process offgases are thermally after-treated in a combustion chamber;
the thermally after-treated process offgas is conveyed via a cooler through an agglomeration stage and solid particles present in the after-treated process offgas can be separated off in a scrubbing stage.

2. Apparatus according to claim 1, wherein the cooler is configured as a quenching stage with a feed facility for a scrubbing liquid.

3. Apparatus according to claim 1 wherein the flow velocity of the process offgas is reduced in the agglomeration stage.

4. Apparatus according to claim 1, wherein the internal volume and/or the free internal cross section of the agglomeration stage is at least approximately at least as large as the internal volume and/or the free internal cross section of the combustion chamber.

5. Apparatus according to claim 1, wherein agglomeration nuclei are present in or can be introduced into the agglomeration stage.

6. Apparatus according to claim 5, wherein the agglomeration nuclei are liquid droplets which have been sprayed in.

7. Apparatus according to claim 1, wherein ultrasound waves can be emitted into the agglomeration stage.

8. Apparatus according to claim 1, wherein the interior wall of the agglomeration stage is wetted with a film of a scrubbing liquid.

9. Apparatus according to claim 1, wherein the agglomeration stage is formed by a plurality of vessels which are arranged in series and/or in parallel.

10. Apparatus according to claim 1, wherein the scrubbing stage is provided with a driving jet of scrubbing liquid or is configured as a spray scrubber and/or packed scrubbing column.

11. Apparatus according to claim 1, wherein the process offgas leaving the scrubbing stage is conveyed through at least one electrostatic precipitator to separate fine solid particles from the after-treated process offgas.

12. Apparatus according to claim 11, wherein the process offgas is conveyed alternately through one of at least two electrostatic precipitators.

13. Apparatus according to claim 11 wherein a feed facility for a scrubbing liquid is present on one electrostatic precipitator.

14. Apparatus according to claim 1, wherein quench stage and electrostatic separator(s) are connected to a stock vessel for a first scrubbing liquid and also agglomeration stage and scrubbing stage are connected to a stock vessel for a second scrubbing liquid.

15. Process for the separation of particles from thermally after-treated process offgases, in which the process offgas which has been thermally after-treated in a combustion chamber is cooled and an enlargement of the particle size of solid particles present in the process offgas is carried out by agglomeration of fine solid particles in an agglomeration stage; and
solid particles are separated from the after-treated process offgas in a scrubbing stage.

16. Process according to claim 15, wherein the process offgas taken off from the combustion chamber is cooled to a temperature below the boiling point of a scrubbing liquid in a quench stage as cooler and is then fed to the agglomeration stage.

17. Process according to claim 15 or 16, wherein a residence time in the agglomeration stage of at least 10 s is adhered to for the agglomeration.

18. Process according to claim 15, wherein the agglomeration is aided by means of agglomeration nuclei present in and/or introduced into the agglomeration stage.

19. Process according to claim 18, wherein liquid droplets are sprayed in to aid the agglomeration.

20. Process according to claim 15, wherein the agglomeration is aided by thermophoresis by maintaining a minimum temperature of the after-treated process offgas introduced into the agglomeration stage.

21. Process according to claim 15, wherein the agglomeration is aided by means of ultrasound waves.

22. Process according to claim 15, wherein the process offgas is conveyed through at least one electrostatic precipitator subsequent to the scrubbing stage to separate off fine solid particles.

23. Process according to claim 22, wherein the process offgas is conveyed alternately through at least two electrostatic precipitators.

24. Process according to claim 23, wherein a particle separation is carried out in one electrostatic precipitator and cleaning is carried out in parallel thereto in at least one other electrostatic precipitator.

25. Process according to claim 15, wherein at least two scrubbing liquids of differing consistency are used in individual process steps.
